(19) United States
(12) Patent Application Publication
(10) Pub. No.: US 2007/0129100 A1
(43) Pub. Date: Jun. 7, 2007

(54) Data input device using magnetic force sensor and method for calculating three-dimensional coordinates using the same

(75) Inventor: Min-Seok Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/601,525

(22) Filed: Nov. 17, 2006

(30) Foreign Application Priority Data
Nov. 17, 2005 (KR) 2005-0110255

(51) Int. Cl. H04M 1/00

(52) U.S. Cl. 455/550.1

(57) ABSTRACT

Provided are a data input device using a magnetic force sensor and a method for calculating 3D coordinates using the same. The data input device having at least one display unit includes at least three magnetic force sensors installed in predetermined locations of the data input device at predetermined intervals; an auxiliary input unit for inputting data while moving over a 3D space within a sensing range of the magnetic force sensors, the auxiliary input unit having a magnet at an end portion; and a controller for calculating 3D coordinates of the auxiliary input unit using magnetic force of the magnet, which is detected by the magnetic force sensors. The desired data can be input to the portable terminal simply through the movement of the auxiliary input unit in the predetermined input space adjacent to the outside of the portable terminal.

### PRIORITY

This application claims priority under 35 U.S.C. § 119 to an application entitled “Data Inputting Device Using Magnetic Force Sensor and Method for Calculating Three Dimensional Coordinates Using It” filed in the Korean Intellectual Property Office on Nov. 17, 2005 and assigned Serial No. 2005-110255, the contents of which are incorporated herein by reference.

### BACKGROUND OF THE INVENTION

1. Field of the Invention

The present invention relates generally to an apparatus and method for inputting data using an auxiliary input unit in various kinds of terminals, and in particular, to a data input device using a magnetic force sensor and a method for calculating three-dimensional (3D) coordinates using the same, in which data can be input to a portable terminal by using an auxiliary input unit at locations above or near the portable terminal.

2. Description of the Related Art

With the development of various electronic and communication technology, device manufacturers are competitively developing devices having a variety of functions that are more convenient to users. For example, as terminals are smaller, lighter and slimmer, diversity of functions becomes an important issue. Therefore, there is a demand for terminals that can provide an Internet function as well as a telephone function and process text information and graphics. To satisfy users' demands, a liquid crystal display (LCD) used as a display unit is larger in size, whereas the terminals are smaller in overall size. For these reasons, touch screens or touch pads having no separate keypads are widely used. Terminals using the touch screens are applied to Personal Digital Assistants (PDAs), notebook computers, domestic appliances, information desks, and so on.

Users can input data through the touch screens or touch pads by using a finger or an auxiliary input unit. As the auxiliary input unit, there is a stylus pen that is detachable from a predetermined location of the terminal or device. The stylus pen has a sharp end portion so that items displayed on a screen can be manipulated simply and delicately.

However, the touch-screen or touch-pad type terminals or devices using the auxiliary input unit such as the stylus pen are expensive because the touch screen or touch pad is attached on the LCD. Also, because data input is achieved by contacting the end portion of the auxiliary input unit with the top surface of the screen, the display unit is easily worn, damaged or scratched if it is used for a long time. Consequently, the data input quality and reliability of the devices are degraded.

### SUMMARY OF THE INVENTION

An object of the present invention is to substantially solve at least the above problems and/or disadvantages and to provide at least the advantages below. Accordingly, an object of the present invention is to provide a data input device using a magnetic force sensor and a method for calculating 3D coordinates using the same, in which data input can be achieved without any direct contact with a display unit, thereby preventing the degradation of the reliability of the products, which may be caused by abrasion and damage when the data input device is used for a long time.

Another object of the present invention is to provide a data input device using a magnetic force sensor and a method for calculating 3D coordinates using the same, in which data input can be performed excellently at a low manufacturing cost.

A further object of the present invention is to provide a data input device using a magnetic force sensor and a method for calculating 3D coordinates using the same, in which data can be input to a portable terminal simply through movement in a 3D space without contacting a display unit.

Still another object of the present invention is to provide a data input device using a magnetic force sensor and a method for calculating 3D coordinates using the same, in which data can be input to a portable terminal simply through movement at a location near the display unit, thereby maximizing user convenience.

According to one aspect of the present invention, a data input device having at least one display unit includes at least three magnetic force sensors installed in predetermined locations of the data input device at predetermined intervals; an auxiliary input unit for inputting data while moving over a 3D space within a sensing range of the magnetic force sensors, the auxiliary input unit having a magnet at an end portion; and a controller for calculating 3D coordinates of the auxiliary input unit using a magnetic force of the magnet, which is detected by the magnetic force sensors.

According to another aspect of the present invention, in a data input device having at least three magnetic force sensors installed in predetermined locations of the data input device at predetermined intervals, an auxiliary input unit for inputting data while moving over a 3D space within a sensing range of the magnetic force sensors, the auxiliary input unit having a magnet at an end portion, and a controller for calculating 3D coordinates of the auxiliary input unit using a magnetic force of the magnet, which is detected by the magnetic force sensors, a method for calculating a 3D space coordinate of the auxiliary input unit of the data input device includes determining whether a current mode is a 3D input mode in which data is input using the auxiliary input unit in the 3D space; when the current mode is the 3D input mode, performing a sensor calibration using at least two or more measured values that are initially input to the data input device by a user; and calculating a current coordinate of the auxiliary input unit using respective distances between the auxiliary input unit and the magnetic force sensors, the respective distances being calculated during the sensor calibration when the data are input using the auxiliary input unit in the 3D space.

According to the present invention, instead of an expensive touch screen or touch pad, cheap magnetic force sensors are used and a magnet is installed in the auxiliary input unit, thereby reducing the manufacturing cost.

Also, data can be input to the display unit using a simple arithmetic expression by calculating 3D coordinate values according to the spatial locations of the auxiliary input unit.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of a portable terminal and an auxiliary input unit according to the present invention;

FIG. 2 is a schematic view of a magnetic force sensor of FIG. 1 according to the present invention;

FIG. 3 is a block diagram of a portable terminal according to the present invention; and

FIG. 4 is an exemplary view explaining a method for calculating 3D coordinates using the data input device according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Although a folder type terminal is illustrated in the drawings and will be described below, the present invention can also be applied to various kinds of terminals or electronic devices, which use an auxiliary input unit and can calculate 3D coordinates.

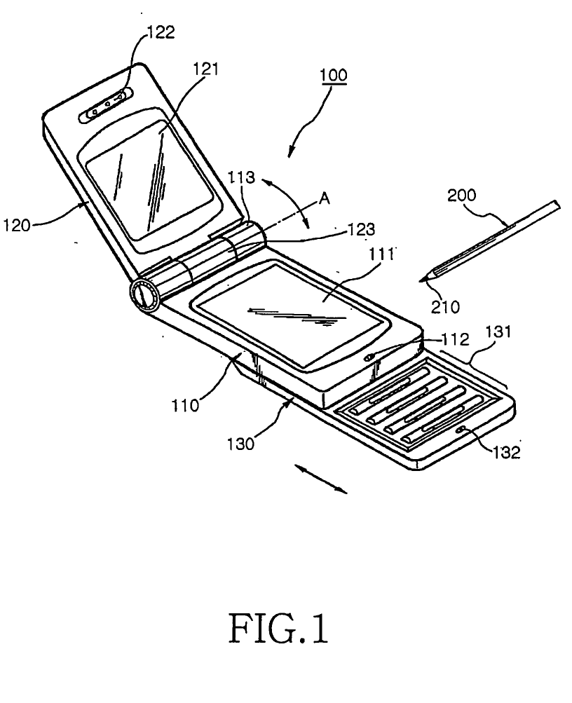

FIG. 1 is a perspective view of a portable terminal 100 and an auxiliary input unit 200 according to the present invention. Referring to FIG. 1, the portable terminal 100 includes a main body 110, a slide body 130 disposed under the main body 110, and a folder 120 configured to be folded on the main body 110.

A main display unit 121 is installed in the folder 120 and a speaker 122 is installed above the main display unit 121. Although not shown, a camera lens assembly for capturing an object may be further installed at a predetermined location on a rear surface of the folder 120 or the main body 110. A hinge module (not shown) enables the folder 120 to rotate around an axis A of FIG. 1 at a predetermined angle with respect to the main body 110. The hinge module is provided with the combination of a center hinge arm and two side hinge arms 113.

A slave display unit 111 is installed in the main body 110. The slave display unit 111 is implemented to display data according to an operation of inputting data by using the auxiliary input unit 200 in a predetermined input space near the portable terminal. The slave display unit 111 may be, but is not limited to, a high-definition color thin film transistor (TFT) LCD module. Data may be displayed on the main display unit 121 according to the data input operation using the auxiliary input unit 200. A microphone 112 is installed below the slave display unit 111.

The slide body 130 having a keypad assembly 131 as a data input device is installed under the main body 110. The keypad assembly 131 has a plurality of key buttons. The slide body 130 slides in a lengthwise direction of the portable terminal 100 by a predetermined distance. The keypad assembly 131 is disposed on the slide body 130. Preferably, the keypad assembly 131 may include 3×4 array of alphanumeric buttons.

A pen type auxiliary input unit, called a stylus pen, may be used as the auxiliary input unit. A magnet 210 having a predetermined magnetic force is installed in an end portion of the auxiliary input unit 200. The auxiliary input unit 200 may be called a magnetic input unit. Therefore, if the user performs a data input operation within the input space, data can be input to the portable terminal by using a plurality of magnetic force sensors installed in the portable terminal to detect a magnetic force.

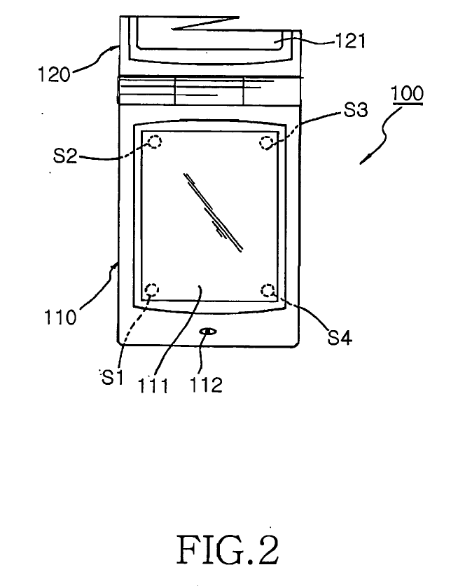

FIG. 2 is a schematic view illustrating locations of the magnetic force sensors S1, S2, S3 and S4 in the portable terminal 100 of FIG. 1. Referring to FIG. 2, the magnetic force sensors S1, S2, S3 and S4 are installed at predetermined locations inside the main body 110 where the slave display unit 111 is installed. Although the magnetic force sensors are installed at corners with respect to the slave display unit 111, the present invention is not limited to this arrangement. According to a coordinate calculating method, which will be described below, at least three magnetic force sensors may be installed. Also, the magnetic force sensors may be installed in any location of the portable terminal, depending on the strength of the magnetic force of the magnet 210 installed in the auxiliary input unit 200 and the sensitivity of the magnetic force sensors S1, S2, S3 and S4.

The magnetic force sensors may be mounted in an SMD (surface mounted device) type on a main board in the portable terminal. These sensors may be at predetermined intervals.

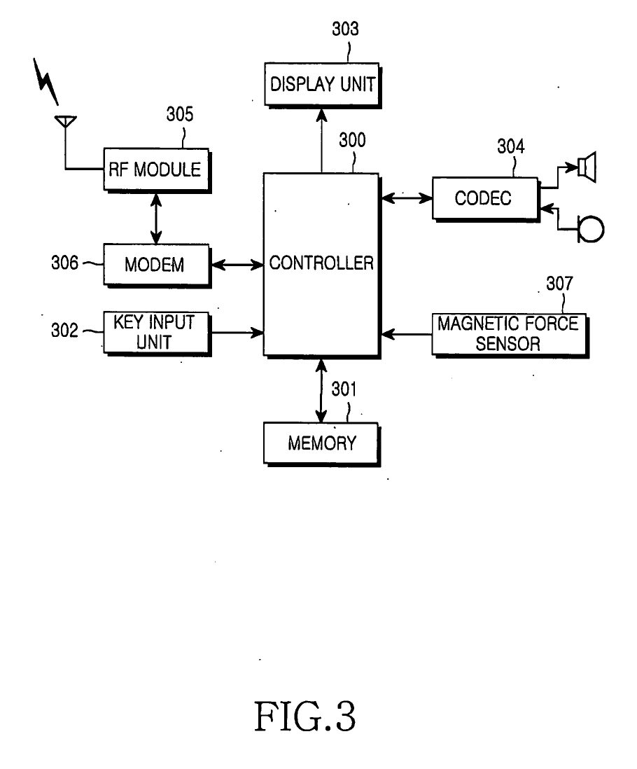

FIG. 3 is a block diagram of a portable terminal according to the present invention. A portable terminal using the magnetic force sensor will be taken as an example. However, the present invention is not limited to this portable terminal.

Referring to FIG. 3, the portable terminal 100 includes a controller (e.g., a microprocessor unit (MPU)) 300, a memory 301, a key input unit 302, a display unit 303, a coder-decoder (CODEC) 304, a radio frequency (RF) module 305, a modem 306, a magnetic force sensor unit 307, a speaker, and a microphone.

The controller 300 controls an overall operation of the portable terminal 100. For example, the controller 300 processes and controls voice communication and data communication. Also, the controller 200 calculates coordinates of data input by a user according to a detecting operation of the magnetic force sensor unit 307, and outputs the calculated coordinates to the display unit 303. As one example, in a 3D input mode in which data is input using the auxiliary input unit 200 within a predetermined input space, when the user prepares for data input operation in the input space near the portable terminal, the magnetic force sensors S1, S2, S3 and S4 installed in the proper locations of the portable terminal 100 detect the user's movement and informs the controller 300. Using the Equations set forth below, the controller 300 calculates 3D space coordinates (x, y, z) of the auxiliary input unit according to the detecting operation of the magnetic force sensors S1, S2, S3 and S4. The calculated 3D space coordinates (x, y, z) of the auxiliary input unit are applied to the main display unit 121 or the slave display unit 111.

If the controller 300 notices that the auxiliary input unit is out of a sensing range of the magnetic force sensors, the 3D input mode may be switched off after a predetermined time elapses.

The memory 301 includes a program memory, a data memory, and a nonvolatile memory. The program memory stores a program for controlling an overall operation of the portable terminal 100.

The key input unit 302 includes numeric keys of digits 0-9 and a plurality of function keys, such as a Menu key, a Cancel (Delete) key, a Confirmation key, a Talk key, an End key, an Internet connection key, and Navigation keys ( [symbol] / [symbol] ). In the key input unit 302, a key input data corresponding to a key pressed by the user is transferred to the controller 300.

The display unit 303 includes the main display unit 121 and the slave display unit 111 and displays data input by the auxiliary input unit on either or both of the two display units 121 and 111. In addition, the display unit 303 displays status information generated during operation of the portable terminal, numerals and characters, moving pictures and still pictures, and so on. A color TFT LCD may be used for the display unit 303.

The CODEC 304 is connected to the controller 300, and the microphone and the speaker are connected to the CODEC 304. The CODEC 304, the microphone, and the speaker serve as a voice input/output block for telephone voice calling. The CODEC 304 converts pulse code modulation (PCM) data provided from the controller 300 into analog audio signals, and the analog audio signals are output through the speaker. Also, the CODEC 304 converts audio signals received through the microphone into PCM data and provides the PCM data to the controller 300.

The RF module 305 down-converts RF signals received through an antenna and provides the down-converted RF signals to the modem 306. The RF module 305 up-converts baseband signals received from the modem 306 and transmits the up-converted signals through the antenna. The modem 306 processes the baseband signals transmitted/received between the RF module 305 and the controller 300. For example, in the case of data transmission, the modem 306 performs a channel coding and a spreading with respect to transmit (TX) data. In the case of data reception, the modem 306 performs a despreading and a channel decoding with respect to receive (RX) data.

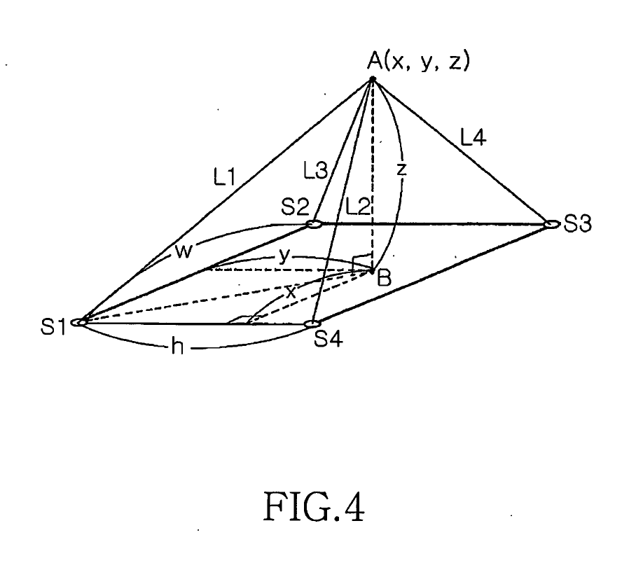

FIG. 4 is an exemplary view explaining a method for calculating 3D coordinates using the data input device according to the present invention. Although four magnetic force sensors are used in the example of FIG. 4, the 3D coordinates can also be calculated using at least three magnetic force sensors.

As illustrated in FIG. 4, a coordinate (x, y, z) of a point A where the auxiliary input unit 200 is located will be calculated. When the auxiliary input unit 200 moves in the input space, 3D space coordinates corresponding to the movement of the auxiliary input unit 200 are successively calculated by the controller 300 and data are input to the display units 111 and 121 of the portable terminal.

When the user initially uses the 3D data input scheme, a sensor calibration of the data input device is carried out. An object of the sensor calibration is to calculate unique constants of the magnetic force sensors S1, S2, S3 and S4 with respect to the magnet 210 installed in the end portion of the auxiliary input unit 200. The respective distances between the magnet 210 of the auxiliary input unit 200 and the sensors S1, S2, S3 and S4 can be calculated using the calculated constants.

The constants are calculated using Equation (1):

$$F = \frac{an}{L {n}^{2}} + bn \qquad ( 1 )$$

where F is a magnetic force of the magnet, Ln (L1, L2, L3, L4) are the respective distances between the magnet of the auxiliary input unit and the sensors, and an (a1, a2, a3, a4) and bn (b1, b2, b3, b4) are constants based on the respective distances between the magnet and the sensors. Therefore, the constants can be calculated by pointing at least two locations within the sensing range of the sensor prior to the initial use of the auxiliary input unit.

Equation (1) is rewritten as Equation (2) and the respective distances L1, L2, L3 and L4 between the magnet 210 of the auxiliary input unit 200 and the sensors S1, S2, S3 and S4 can be calculated using Equation (2):

$$L n = \sqrt{\frac{an}{F - bn}} \qquad ( 2 )$$

Moreover, as illustrated in FIG. 4, the space coordinates of the magnet 210 can be calculated using the location of the sensor S1 as a reference. Based on the Pythagorean Theorem, the respective distances L1, L2, L3 and L3 between the coordinate point A and the sensors can be using Equation (3):
EL1²=x²+y²+z²
EL2²=x²+(h−y)²+z²
EL3²=(w−x)²+y²+z²
EL4²=(w−z)²+(h−y)²+z² (3)
where h is the distance between the sensor S1 and the sensor S4 and w is the distance between the sensor S1 and the sensor S2.

As represented by Equation (3), the respective distances L1, L2, L3 and L4 between the point A where the magnet of the auxiliary input unit is located and the magnetic force sensors can be expressed by the coordinate values x, y and z. The values L1, L2, L3 and L4 can be obtained from Equation (2), and the values h and w can also be obtained.

Therefore, the polynomial expression of Equation (3) can be written as Equation (4) through Equation (6):

$$\begin{matrix}x = \frac{L {1}^{2} - L {3}^{2} + {w}^{2}}{2 w} & ( 4 ) \\ y = \frac{L {1}^{2} - L {2}^{2} + {h}^{2}}{2 h} & ( 5 ) \\ z = \sqrt{L {1}^{2} - [ ( \frac{L {1}^{2} - L {3}^{2} + {w}^{2}}{2 w} ) + ( \frac{L {1}^{2} - L {2}^{2} + {h}^{2}}{2 h} ) ]} & ( 5 )\end{matrix}$$

The values of x, y and z expressed as Equation (4) through Equation (6) are input to the controller 300 of the portable terminal, and the values of L1, L2, L3, L4, h, and w are calculated at each location where the magnet of the auxiliary input unit moves. Through these procedures, the coordinate values according to the movement of the auxiliary input unit in the 3D input space can be obtained. Based on these coordinate values, the controller of the portable terminal can display data on the corresponding positions of the display unit.

Although the coordinate values of x, y and z are calculated using the magnetic force sensor S1 as a reference, they can also be calculated using any one of the other sensors S2, S3 and S4 as a reference. Further, if the magnetic force sensor has good sensitivity and the magnetic force of the magnet installed in the auxiliary input unit is strong, the data can be input to the portable terminal when the auxiliary input unit is used at locations near the portable terminal.

According to the present invention, the desired data can be input to the portable terminal simply through the movement of the auxiliary input unit in the predetermined input space adjacent to the outside of the portable terminal. Therefore, even if the portable terminal is used for a long time, it will not be damaged or abraded because the auxiliary input unit does not contact the touch screen or touch pad. Also, because the space coordinates of the auxiliary input unit are recognized only using several magnetic force sensors, the manufacturing cost can be reduced.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A data input device having at least one display unit, comprising:
at least three magnetic force sensors installed in predetermined locations of the data input device at predetermined intervals;
an auxiliary input unit for inputting data while moving over a 3D space within a sensing range of the magnetic force sensors, the auxiliary input unit having a magnet at an end portion; and
a controller for calculating 3D coordinates of the auxiliary input unit using a magnetic force of the magnet, which is detected by the magnetic force sensors.

2. The data input device of claim 1, wherein the controller sets a 3D space coordinate of the magnet using any one of the magnetic force sensors as a reference.

3. The data input device of claim 2, wherein the magnetic force sensors are mounted in an SMD (surface mounted device) type on a main board of the data input device at predetermined intervals.

4. In a data input device having at least three magnetic force sensors installed in predetermined locations of the data input device at predetermined intervals, an auxiliary input unit for inputting data while moving over a 3D space within a sensing range of the magnetic force sensors, the auxiliary input unit having a magnet at an end portion, and a controller for calculating 3D coordinates of the auxiliary input unit using a magnetic force of the magnet, which is detected by the magnetic force sensors, a method for calculating a 3D space coordinate of the auxiliary input unit of the data input device, comprising the steps of:
determining whether a current mode is a 3D input mode in which data is input using the auxiliary input unit in the 3D space;
when the current mode is the 3D input mode, performing a sensor calibration using at least two or more measured values that are initially input to the data input device by a user; and
calculating a current coordinate of the auxiliary input unit using respective distances between the auxiliary input unit and the magnetic force sensors, the respective distances being calculated during the sensor calibration when the data are input using the auxiliary input unit in the 3D space.

5. The method of claim 4, wherein the magnetic force sensors are installed at four locations of the data input device.

6. The method of claim 5, wherein the magnetic force sensors are mounted in an SMD type on a main board of the data input device.

7. The method of claim 6, wherein the 3D coordinate of the auxiliary input unit is calculated using any one of the magnetic force sensors as a reference.

8. The method of claim 7, wherein when the auxiliary input unit is out of a sensing range of the magnetic force sensors, the 3D input mode is switched off after a predetermined time elapses.

9. The method of claim 8, wherein in measuring the sensor calibration, constants (an, bn, Ln) are calculated using a following equation based on a magnetic force law that the magnetic force is proportional to the square of a distance
$$L n = \sqrt{\frac{an}{F - bn}}$$
where F is a magnetic force of the magnet, Ln (L1, L2, L3, L4) are the respective distances between the magnet of the auxiliary input unit and the magnetic force sensors, and an (a1, a2, a3, a4) and bn (b1, b2, b3, b4) are constants based on the respective distances between the magnet and the magnetic force sensors.

10. The method of claim 9, wherein location coordinates (x, y, z) of the auxiliary input unit in a 3D space are calculated using:
$$x = \frac{L {1}^{2} - L {3}^{2} + {w}^{2}}{2 w}$$
$$y = \frac{L {1}^{2} - L {2}^{2} + {h}^{2}}{2 h}$$
$$z = \sqrt{L {1}^{2} - [ ( \frac{L {1}^{2} - L {3}^{2} + {w}^{2}}{2 w} ) + ( \frac{L {1}^{2} - L {2}^{2} + {h}^{2}}{2 h} ) ]}$$
where L1, L2, L3 and L4 are the respective distances between the magnet of the auxiliary input unit and the magnetic force sensors h is the distance between a reference sensor of the magnetic force sensors and another sensor, and w is the distance between the reference sensor and a further another sensor.

11. A portable terminal comprising:
at least one display unit;
an magnetic input unit for expressing data in a 3D space, the magnetic input unit having a magnet at an end portion; and
at least three magnetic force sensors installed in predetermined locations at predetermined intervals for sensing the data expressed by the magnetic input unit; and
a controller for calculating 3D coordinates of the magnetic input unit using a magnetic force of the magnet which is detected by the magnetic force sensors.

12. The portable terminal of claim 11, wherein the controller sets a 3D space coordinate of the magnet using one of the magnetic force sensors as a reference.

13. The portable terminal of claim 12, wherein the magnetic force sensors are mounted in an SMD (surface mounted device) type.

14. A method for calculating a 3D space coordinate of the auxiliary input unit in a portable terminal, comprising the steps of:
performing a sensor calibration using at least two measured values that are input using a magnetic input unit; and
calculating a current coordinate of the magnetic input unit using respective distances between the magnetic input unit and the magnetic force sensors, the respective distances being calculated during the sensor calibration when the data are input using the magnetic input unit in the 3D space.

15. The method of claim 14, wherein the magnetic force sensors are installed at four locations of the data input device.

16. The method of claim 15, wherein the magnetic force sensors are mounted in an SMD type.

17. The method of claim 16, wherein the 3D coordinate of the magnetic input unit is calculated using one of the magnetic force sensors as a reference.

18. The method of claim 17, wherein when the auxiliary input unit is out of a sensing range of the magnetic force sensors, the 3D input mode is switched off after a predetermined time elapses.

19. The method of claim 18, wherein the sensor calibration is performed by calculating constants (an, bn, Ln) using a following equation based on a magnetic force law that the magnetic force is proportional to the square of a distance
$$L n = \sqrt{\frac{an}{F - bn}}$$
where F is a magnetic force of the magnet, Ln (L1, L2, L3, L4) are the respective distances between the magnet of the magnetic input unit and the magnetic force sensors, and an (a1, a2, a3, a4) and bn (b1, b2, b3, b4) are constants based on the respective distances between the magnet and the magnetic force sensors.

20. The method of claim 19, wherein location coordinates (x, y, z) of the magnetic input unit in a 3D space are calculated using:
$$x = \frac{L {1}^{2} - L {3}^{2} + {w}^{2}}{2 w}$$
$$y = \frac{L {1}^{2} - L {2}^{2} + {h}^{2}}{2 h}$$
$$z = \sqrt{L {1}^{2} - [ ( \frac{L {1}^{2} - L {3}^{2} + {w}^{2}}{2 w} ) + ( \frac{L {1}^{2} - L {2}^{2} + {h}^{2}}{2 h} ) ]}$$
where L1, L2, L3 and L4 are the respective distances between the magnet of the magnetic input unit and the magnetic force sensors h is the distance between a reference sensor of the magnetic force sensors and another sensor, and w is the distance between the reference sensor and a further another sensor.
